(19) United States
(12) Patent Application Publication
(10) Pub. No.: US 2022/0174345 A1
(43) Pub. Date: Jun. 2, 2022

(54) SYSTEMS AND METHODS FOR STORING CONTENT ITEMS BASED ON CONSUMPTION HISTORY

(71) Applicant: Rovi Guides, Inc., San Jose, CA (US)

(72) Inventors: Jeffery Garcia, Campbell, CA (US); David Ly, San Jose, CA (US); Hung Vuong, San Jose, CA (US); Rodney Young, Mountain View, CA (US)

(21) Appl. No.: 17/108,566

(22) Filed: Dec. 1, 2020

(51) Int. Cl. H04N 21/262; H04N 21/231; H04N 21/24

(52) U.S. Cl. CPC H04N 21/26258; H04N 21/26241; H04N 21/2408; H04N 21/23113

(57) ABSTRACT

Systems and methods for generating a notification for display on a device based on consumption history of a content item are disclosed herein. Control circuitry receives a request to store a content item of a series of sequentially ordered content items. The control circuitry determines whether the request is a new request for a user. Upon determining that the request is the new request, the control circuitry stores a predetermined number of content items of the series of sequentially ordered content items in a storage device. If a threshold amount of the predetermined number of content items has not been displayed on a device, then the control circuitry causes the notification to be displayed on the device.

### BACKGROUND

With the increasing popularity of playing media assets over networks such as the Internet, many media assets such as audio-visual content are downloaded or recorded on a user device. Because of the size of the media asset and the limited amount of available storage space on the user device, there is a need for optimizing the storage space and for managing the downloaded content items.

### SUMMARY

The present disclosure addresses the problems described above, by, for example, providing systems and methods for preventing storing of an additional content item when a user has not consumed a previously stored (e.g., recorded) content item of a series of content items. For example, when a user requests to record a content item that is a part of a series of sequentially ordered content items (e.g., “Walking Dead” TV series), the system determines whether the request is a new request. The system may determine whether the user has previously watched the requested content item based on user profile data or whether the requested content item has previously been aired.

Upon determining that the request is a new request, the system may store a predetermined number of content items (e.g., first three episodes) of the series in a storage device. The system may determine whether a threshold amount of the predetermined number of content items has been displayed on the user device. For example, the system may determine whether a threshold number of episodes (e.g., two) out of the previously stored three episodes has been displayed (e.g., watched) or a threshold amount of time (e.g., two hours) has been spent on watching the previously stored episodes.

Upon determining that the threshold amount of the predetermined number of content items has not been displayed, the system displays a notification on the user device alerting the user that the previously stored episodes have not been watched and that the system will not record any more of the new episodes until the user watches the previously stored episodes. For example, suppose the additional content item (e.g., episode 4) is scheduled to be aired on Friday of next week. In that case, the system may provide a notification indicating that the next episode is scheduled to be aired next week and reminding the user of the unwatched content items prior to the scheduled time of the next episode (e.g., next Friday).

In one embodiment, the system may delete the unwatched episodes from the storage device unless the user watches the content items by a specific date set by the system. For example, in order to maximize the storage capacity, the system may delete the previously stored content items in response to determining that the threshold amount of the predetermined number of content items has not been watched.

In some embodiments, the system may identify multiple users that are associated with the device on which the media asset is displayed or stored. For example, in a home network, multiple users may share the device (e.g., living room TV). In that case, the system may identify a specific user account when the content item is consumed. Based on the specific user account and the consumption history of the specific user account, the system may determine whether a notification needs to be displayed. For example, if user A (e.g., Tom) consumes more than the threshold amount of the previously stored content items, then the system prevents the notification from being displayed on user A's account. On the other hand, if user B (e.g., Bob) consumes less than the threshold amount of the previously stored content items, then the system causes the notification (e.g., reminder) to be displayed on the user B's account.

Accordingly, the systems and methods described herein provide a better and improved way of automatically managing the storage space and maximizing the storage capacity by minimizing the actions that would otherwise be taken by a user (e.g., moving the content item to a cloud space or deleting unwatched content items).

It should be noted that the systems, methods, apparatuses, and/or aspects described above may be applied to, or used in accordance with, other systems, methods, apparatuses, and/or aspects described in this disclosure.

### DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative block diagram of a system for providing a notification based on consumption history, in accordance with some embodiments of the disclosure;

FIG. 2 depicts an illustrative block diagram showing additional details of the system for providing the notification based on consumption history, in accordance with some embodiments of the disclosure;

FIG. 3 depicts an illustrative flowchart of a process for providing a notification of unwatched content items based on consumption history, in accordance with some embodiments of the disclosure;

FIG. 4 shows an exemplary depiction for storing a content item on an illustrative device, in accordance with some embodiments of the disclosure;

FIG. 5 shows an exemplary depiction for providing the content item for display on the illustrative device, in accordance with some embodiments of the disclosure; and

FIG. 6 shows an exemplary depiction for providing the notification of an unwatched content item based on consumption history on the illustrative device, in accordance with some embodiments of the disclosure.

### DETAILED DESCRIPTION

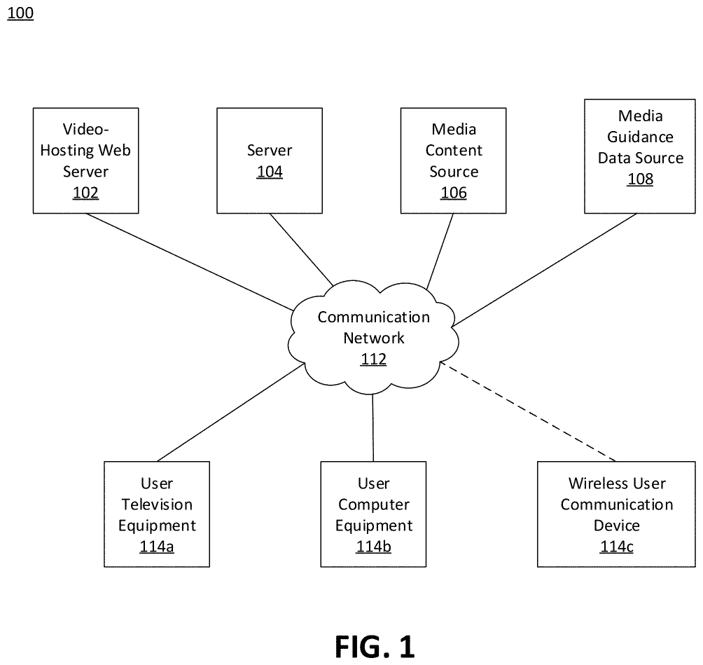

FIG. 1 shows an illustrative block diagram of a system 100 for providing a notification based on consumption history, in accordance with some embodiments of the disclosure. In one aspect, system 100 includes one or more of video web server 102, server 104, media content source 106, media guidance data source 108, and communication network 112. Communication network 112 may be one or more networks including the Internet, a mobile phone network, mobile voice or data network (e.g., a 4G or LTE network), cable network, public switched telephone network, or other types of communication network or combinations of communication networks. Communication network 112 includes one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. Communication network 112 communicatively couples various components of system 100 to one another. For instance, server 104 may be communicatively coupled to video web server 102, media content source 106, and/or media guidance data source 108 via communication network 112. Video web server 102 hosts one or more video websites, such as YOUTUBE, and/or the like, that enable users to download videos, video clips, and/or other types of content. In addition to enabling users to download and view content, the video websites also provide access to data regarding downloaded content.

In some examples, media content source 106 and media guidance data source 108 may be integrated as one device. Media content source 106 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 106 may be the originator of content (e.g., a television broadcaster, a Webcast provider, etc.) or may not be the originator of content (e.g., an on-demand content provider, an Internet provider of content of broadcast programs for downloading, etc.). Media content source 106 may include cable sources, satellite providers, on-demand providers, Internet providers, over-the-top content providers, or other providers of content. Media content source 106 may also include a remote media server used to store different types of content (e.g., including video content selected by a user) in a location remote from computing device 114 (described below). Systems and methods for remote storage of content and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 108 may provide media guidance data, such as the media guidance data described herein, to computing device 114 and/or server 104 using any suitable approach. In some embodiments, media guidance data source 108 may provide a stand-alone interactive television program guide that receives program guide data via a data feed (e.g., a continuous feed or trickle feed). In some examples, media guidance data source 108 may provide program schedule data and other guidance data to computing device 114 on a television channel sideband, using an in-band digital signal, using an out-of-band digital signal, or by any other suitable data transmission technique.

In some embodiments, guidance data from media guidance data source 108 may be provided to computing device 114 using a client/server approach. For example, computing device 114 may pull media guidance data from a server (e.g., server 104), or a server may push media guidance data to computing device 114. In some embodiments, a client application residing on computing device 114 may initiate sessions with media guidance data source 108 to obtain guidance data when needed, e.g., when the guidance data is out-of-date or when computing device 114 receives a request from the user to receive data.

Content and/or media guidance data delivered to computing device 114 may be over-the-top (OTT) content. OTT content delivery allows Internet-enabled user devices, such as computing device 114, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute applications (e.g., web-based applications or cloud-based applications), or the content can be displayed by applications stored on computing device 114.

As described in further detail below, server 104 accesses the content of the video website(s) hosted by video web server 102 and, based on the accessed content, generates a variety of types of data and/or metadata (e.g., terms, associations between terms and corresponding media content identifiers, relevance scores indicating the relevance of terms to corresponding media content identifiers, and/or the like) and can be accessed to facilitate the searching of media content made available by media content source 106. System 100 also includes one or more computing devices 114, such as user television equipment 114a (e.g., a set-top box), user computer equipment 114b, and wireless user communication device 114c (e.g., a smartphone device or a remote control), that users can use to interact with server 104, media guidance data source 108, and/or media content source 106, via communication network 112, to search for desired media content. For instance, in some aspects, server 104 may provide a user interface via computing device 114, by which a user can input a keyword-based query for a particular item of media content made available by media content source 106, and generate a response to the query by accessing and/or processing data and/or metadata. Although FIG. 1 shows one of each component, in various examples, system 100 may include multiples of one or more illustrated components. For instance, system 100 may include multiple video web servers 102 and server 104 may aggregate data from the multiple video websites hosted by multiple video web servers 102, respectively.

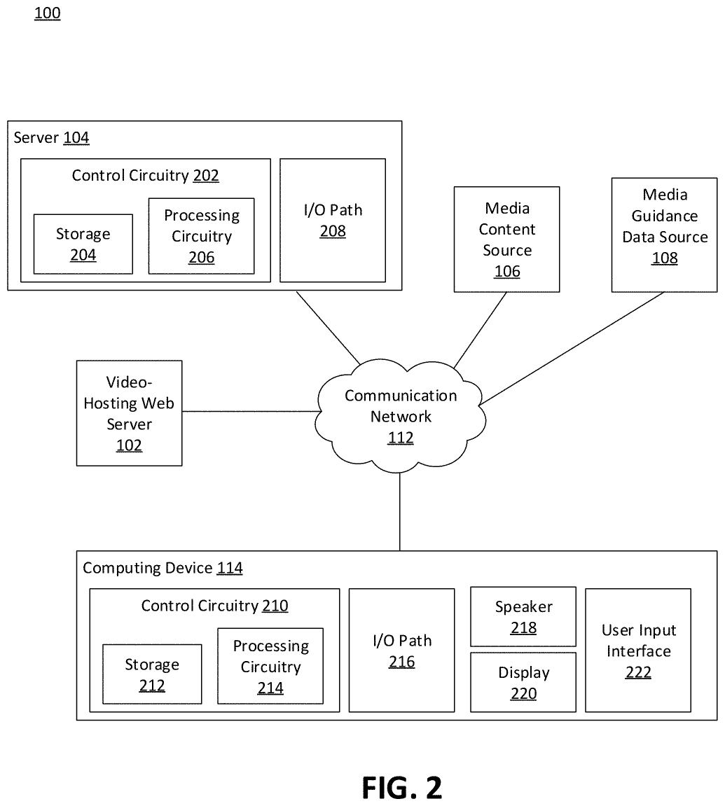

FIG. 2 is an illustrative block diagram showing additional details of the system 100 for generating media program keywords of FIG. 1, in accordance with some embodiments of the disclosure. In particular, server 104 includes control circuitry 202 and Input/Output (I/O) path 208, and control circuitry 202 includes storage 204 and processing circuitry 206. Computing device 114 includes control circuitry 210, I/O path 216, speaker 218, display 220, and user input interface 222. Control circuitry 210 includes storage 212 and processing circuitry 214. Control circuitry 202 and/or 210 may be based on any suitable processing circuitry such as processing circuitry 206 and/or 214. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 204, storage 212, and/or storages of other components of system 100 (e.g., storages of media content source 106, media guidance data source 108, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Each of storage 204, storage 212, and/or storages of other components of system 100 may be used to store various types of content, media guidance data, and or other types of data. Non-volatile memory may also be used (e.g., to launch a boot-up routine and other instructions). Cloud-based storage may be used to supplement storages 204, 212 or instead of storages 204, 212. In some embodiments, control circuitry 202 and/or 210 executes instructions for an application stored in memory (e.g., storage 204 and/or 212). Specifically, control circuitry 202 and/or 210 may be instructed by the application to perform the functions discussed herein. In some implementations, any action performed by control circuitry 202 and/or 210 may be based on instructions received from the application. For example, the application may be implemented as software or a set of executable instructions that may be stored in storage 204 and/or 212 and executed by control circuitry 202 and/or 210. In some embodiments, the application may be a client/server application where only a client application resides on computing device 114, and a server application resides on server 104.

The application may be implemented using any suitable architecture. For example, it may be a stand-alone application wholly implemented on computing device 114. In such an approach, instructions for the application are stored locally (e.g., in storage 212), and data for use by the application is downloaded on a periodic basis (e.g., from an out-of-band feed, from an Internet resource, or using another suitable approach). Control circuitry 210 may retrieve instructions for the application from storage 212 and process the instructions to perform the functionality described herein. Based on the processed instructions, control circuitry 210 may determine what action to perform when input is received from user input interface 222.

In client/server-based embodiments, control circuitry 210 may include communication circuitry suitable for communicating with an application server (e.g., server 104) or other networks or servers. The instructions for carrying out the functionality described herein may be stored on the application server. Communication circuitry may include a cable modem, an integrated services digital network (ISDN) modem, a digital subscriber line (DSL) modem, a telephone modem, an Ethernet card, or a wireless modem for communication with other equipment, or any other suitable communication circuitry. Such communication may involve the Internet or any other suitable communication networks or paths (e.g., communication network 112). In another example of a client/server-based application, control circuitry 210 runs a web browser that interprets web pages provided by a remote server (e.g., server 104). For example, the remote server may store the instructions for the application in a storage device. The remote server may process the stored instructions using circuitry (e.g., control circuitry 202) and generate the displays discussed above and below. Computing device 114 may receive the displays generated by the remote server pap and may display the content of the displays locally via display 220. This way, the processing of the instructions is performed remotely (e.g., by server 104) while the resulting displays are provided locally on computing device 114. Computing device 114 may receive inputs from the user via input interface 222 and transmit those inputs to the remote server for processing and generating the corresponding displays.

A user may send instructions to control circuitry 202 and/or 210 using user input interface 222. User input interface 222 may be any suitable user interface, such as a remote control, trackball, keypad, keyboard, touchscreen, touchpad, stylus input, joystick, voice recognition interface, or other user input interfaces. User input interface 222 may be integrated with or combined with display 220, which may be a monitor, a television, a liquid crystal display (LCD), electronic ink display, or any other equipment suitable for displaying visual images.

Server 104 and computing device 114 may receive content and data via I/O paths 208 and 216, respectively. I/O paths 208, 216 may provide content (e.g., broadcast programming, on-demand programming, Internet content, content available over a local area network (LAN) or wide area network (WAN), and/or other content) and data to control circuitry 202, 210. Control circuitry 202, 210 may be used to send and receive commands, requests, and other suitable data using I/O paths 208, 216. I/O paths 208, 216 may connect control circuitry 202, 210 (and specifically processing circuitry 206, 214) to one or more communication paths (described below). I/O functions may be provided by one or more of these communication paths but are shown as single paths in FIG. 2 to avoid overcomplicating the drawing.

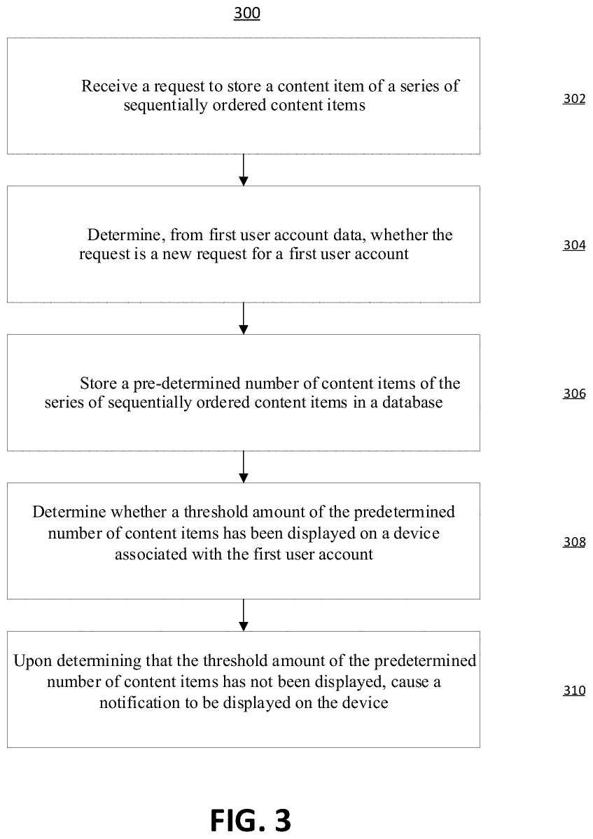

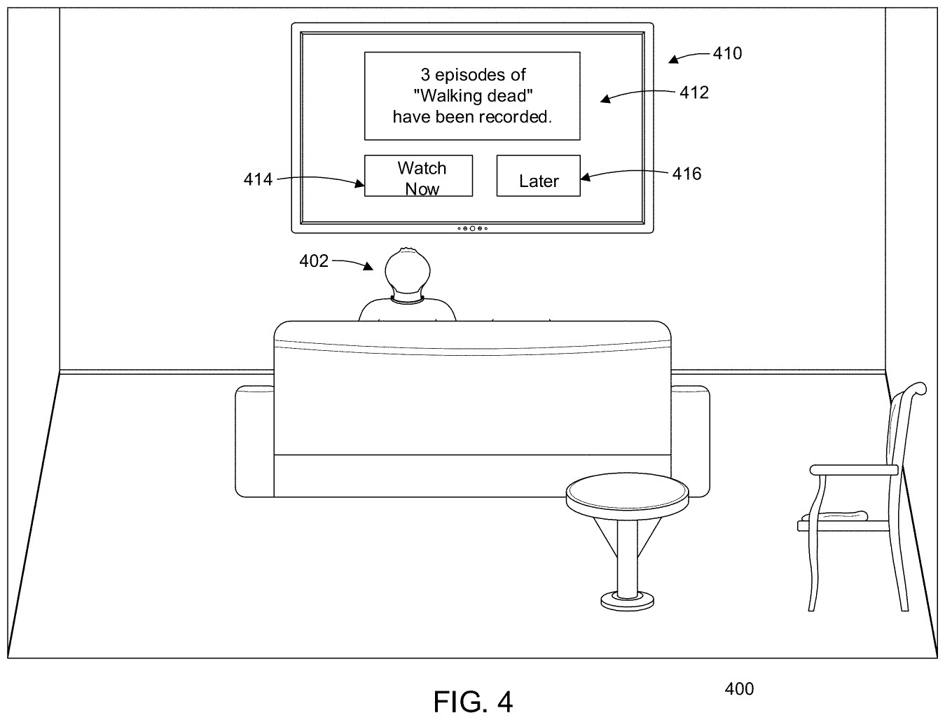

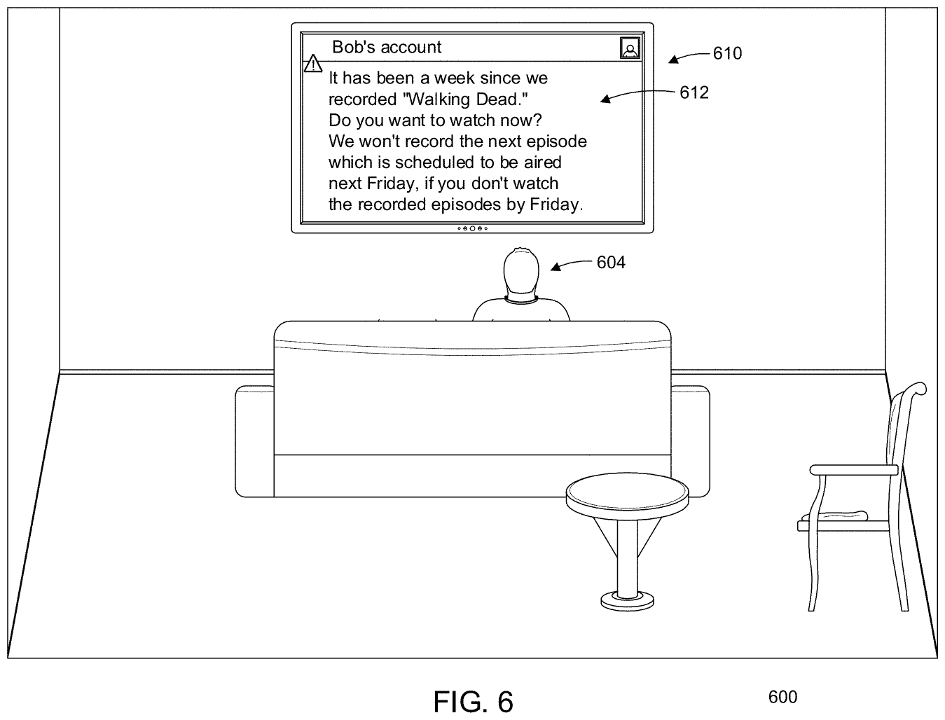

Having described system 100, reference is now made to FIG. 3, which depicts an illustrative flowchart of process 300 for providing a notification of unwatched content items based on consumption history that may be implemented by using system 100 in accordance with some embodiments of the disclosure. Reference is also made to FIG. 4, FIG, 5, and FIG. 6, which show example embodiments generated by system 100 and process 300, in accordance with some embodiments.

At 302, control circuitry 202 receives a request to store a content item of a series of sequentially ordered content items. The request to store the content item may be a request to record or download the content item. The requested content item may be stored in storage 204, 212, or any cloud storage associated with video web server 102 or media content source 106. The requested content item may be a part of a series of sequentially ordered content items (e.g., episode 1 of the “Walking Dead” TV series or first movie of Harry Potter movie series).

At block 304, control circuitry 202 determines whether the request is a new request for a user account. Control circuitry 202 retrieves user account data (e.g., profile data) associated with a device on which the content item is to be displayed. Based on the retrieved user account data, the control circuitry may determine whether the user has previously watched the requested content item or whether the requested content item has previously been aired. For example, if the user has not previously watched the requested content item, then control circuitry 202 determines that the request is a new request. Similarly, if the requested content item is a newly introduced show and has never been aired before, then control circuitry 202 determines that the request is a new request.

At block 306, control circuitry 202 stores a predetermined number of content items (e.g., first three episodes) of the series in storage 204, 212. This allows control circuitry 202 to determine a user's interest in the stored content items. Instead of storing all the content items that are available for downloading, control circuitry 202 stores only a predetermined number of content items to maximize the storage capacity. Control circuitry 202 may monitor user consumption history on the content items, and based on the user consumption history, control circuitry 202 determines whether the user likes the requested content item before storing additional content items of the series.

In one embodiment, the predetermined number of content items can be specified based on system-configurable parameters or user-configurable parameters. For example, the system or the user may configure the predetermined number to be a specific number based on a type of content item, such as three for a TV series (e.g., shorter content item) and one for a movie series (e.g., longer content item). Alternatively, the system may configure the predetermined number to be based on attributes of content items such as a celebrity who is starring in a requested content item or genre of a content item. For example, the system may configure the predetermined number to be higher for a content item starring a user's favorite actor than for a content item starring a user's less favored actor. The system may configure the predetermined number to be higher for a content item that is categorized as a user's favorite genre (e.g., horror) than for a content item that is categorized as a user's less favored genre (e.g., romance).

At block 308, control circuitry 202 may determine whether a threshold amount of the predetermined number of content items has been displayed (e.g., played) on computing device 114. Control circuitry 202 may monitor content consumption history by the user to determine how much of the predetermined number of content items has been watched by the user (e.g., two episodes or 60%). Based on the content item consumption history, control circuitry 202 may determine a user's interest in the stored content item.

Similar to the predetermined number, the threshold amount can be specified based on system-configurable parameters or user-configurable parameters. The threshold amount can be specified based on at least one of a type of content item, a genre of a content item, or an actor who stars in the content item, or any other suitable method of identifying the content item. The threshold amount can also be measured based on a number of content items or an amount of time spent on the content item. For example, the system may configure the threshold amount to be a number of episodes (e.g., two episodes) for TV series content item or an amount of time (e.g., 1 hour) for a movie content item.

At block 310, if control circuitry 202 determines that the threshold amount of the predetermined number of content items has not been displayed on the user device, then control circuitry 202 displays a notification on computing device 114 and prevents storing additional content items of the series of sequentially ordered content items.

The notification may indicate that the requested content item has not yet been watched and remind the user to watch the requested content item. The notification may also include a time frame in which the user should watch the requested content item. For example, control circuitry 202 may retrieve media guidance data from the media guidance data source 108 and determine that the next episode (e.g., episode 4 of the “Walking Dead” TV series) is scheduled to be aired next Friday. Based on the media guidance data, control circuitry 202 may display the next episode's scheduling information to remind the user of the unwatched content item and remind the user to watch the unwatched content item before the next scheduled transmission time.

In order to save the storage space in some embodiments, control circuitry 202 may delete one or more of the unwatched content items from storage 204, 212 if the user does not watch the stored content items by a specified date. The due date may be any date that the control circuitry 202 or the user configures (e.g., three months from the download date).

In some embodiments, in order to maximize the storage capacity, the control circuitry 202 may prevent storing additional content items (e.g., episode 4 of the “Walking Dead” TV series) if the threshold amount of the predetermined number of content items is not consumed. Control circuitry 202 may determine a level of the user's interest in the unwatched content item based on the user consumption history of the content item and may stop storing additional content items if the user consumes less than the threshold amount. Unless the user watches the unconsumed content items, control circuitry 202 may not record any additional content items, even though the additional content items continue to be aired.

On the other hand, if the control circuitry 202 determines that the threshold amount of the predetermined number of content items has been displayed on the user device, then control circuitry 202 may not display the notification on computing device 114. In addition, the control circuitry 202 may continue to store the next or additional content item of the series of the sequentially ordered content items in storage 212, 214 when the next or additional content item becomes available for transmission.

FIG. 4 shows an exemplary depiction 400 for storing content items on an illustrative device, in accordance with some embodiments of the disclosure. Exemplary depiction 400 shows a user 402 with computing device 410 in a room.

In one embodiment, control circuitry 202 may receive user profile information for a user account of user 402 associated with computing device 410. The user profile information may include a user's preference in genres of content items or a user's favorite specific celebrity (e.g., actor or sports player). For example, a user may indicate that the user is more interested in a horror content item than a romance content item. A user may indicate that the user is interested in watching a content item in which a particular actor stars. Based on the user profile data, control circuitry 202 may store a content item when the content item stars the particular actor or when a horror content item is aired via communication network 112. Storing the content item based on the user profile information may be performed without receiving a user request to record the content item.

In a related embodiment, control circuitry 202 may receive a request from a user account of user 402 associated with computing device 410. Anytime before the content item is available for transmission or during the transmission, a request may be received to store the content item. When a request to record a content item is received, control circuitry 202 records the requested content item in storage 202, 214. Once the content item is ready for viewing, control circuitry 202 populates a message 412 for display indicating that the requested content item has been recorded. In exemplary depiction 400, control circuitry 202 generates message 412 on display 220 of computing device 410 indicating that “‘Walking Dead’ has been recorded.”

In some embodiments, message 412 may include selectable options 414, 416 that can be selected via input interface 222 of computing device 410. Each selectable option may be associated with a respective instruction related to the stored content item. In exemplary depiction 400, message 412 includes a “Watch now” option 414 and a “Later” option 416. User selection of option 414 instructs control circuitry 202 to retrieve and display the content item and user selection of option 416 instructs control circuitry 202 not to display the content item.

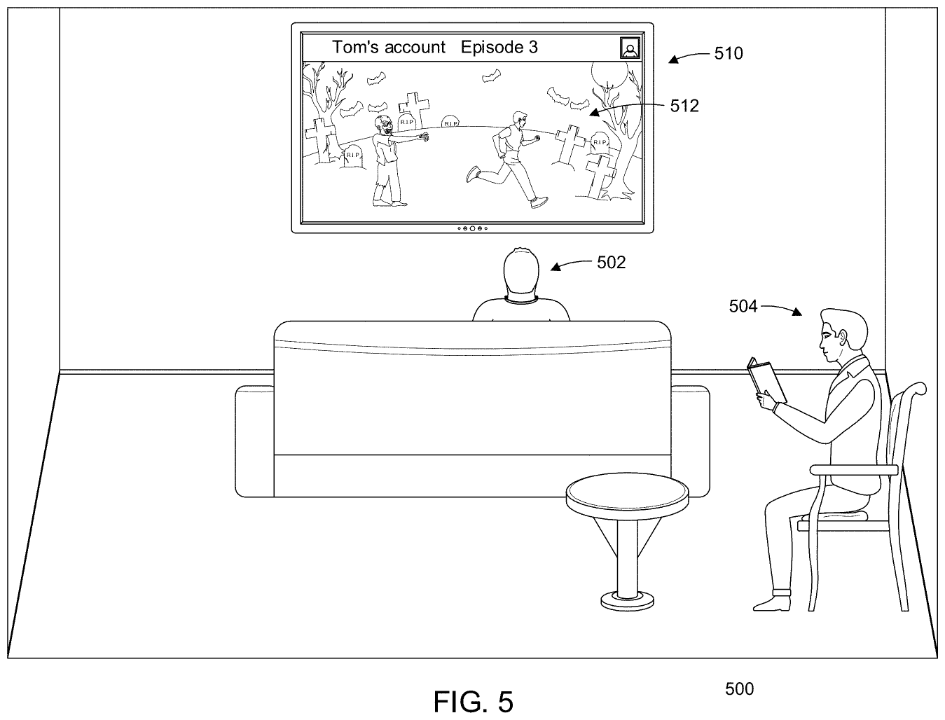

FIG. 5 shows an exemplary depiction 500 for providing a content item for display on the illustrative device, in accordance with some embodiments of the disclosure. Exemplary depiction 500 shows user 502 (e.g., Tom) watching the requested content item 512 on computing device 510 and user 504 (e.g., Bob) reading a book on the other side of the room.

The control circuitry 202 may identify one or more user accounts associated with computing device 510. For example, in a home network, more than one user account may be associated with computing device 510. Control circuitry 202 may determine a specific user who is engaged with computing device 510 indicative of a particular user account. For example, control circuitry 202 may detect that user 502 is within proximity of computing device 510 using a facial recognition technique and identify a user account associated with the detected user 502 within proximity of computing device 510. In another example, control circuitry 202 may detect that user 502 is wearing a wearable device (not shown) connected to computing device 510 and identifies a specific user account associated with the wearable device. In a related example, control circuitry 202 may detect that user 502 is attempting to sign in with computing device 510 and determine the user account associated with the signed-in user 502.

Control circuitry 202 accesses the identified user profile and determines whether the identified user 502 has watched the stored content item. In this example, Tom is watching episode 3 of “Walking Dead.” As a result, control circuitry 202 may determine that Tom has watched more than a threshold amount (e.g., two episodes) of the stored content items of the series. Upon determining that Tom has watched more than the threshold amount, control circuitry 202 may record an additional content item (e.g., episode 4 of “Walking Dead”) when the additional content item is available for downloading. Upon determining that Tom has watched more than the threshold amount, a reminder notification may not be provided for Tom.

On the other hand, FIG. 6 shows an exemplary depiction 600 for providing a notification 612 of unwatched content items for Bob's account. Exemplary depiction 600 shows a different user account for user 604 (e.g., Bob) that is also associated with computing device 610. Control circuitry 202 may identify that Bob is engaged with computing device 610 instead of Tom and generates a relevant notification on Bob's account. For example, control circuitry 202 monitors consumption history for Bob from Bob's profile data and determines that Bob has watched less than the threshold amount of the predetermined content items, because Bob was reading a book and was not watching the recorded content item in FIG. 5. Upon determining that Bob has not watched the threshold amount of the content item, control circuitry 202 may determine that Bob is not interested in “Walking Dead” and stop storing an additional “Walking Dead” episode even when a new episode is available for download or is scheduled to be aired.

In some embodiments, control circuitry 202 may generate notification 612 on display 220 of computing device 610. Notification 612 may include different types of messages based on different embodiments disclosed herein. For example, notification 612 may be a reminder that prompts the user to start playback of the stored content item. Notification 612 may be a message that notifies the user that an additional content item of the series of sequentially ordered content items will not be recorded or stored. Notification 612 may be a message that alerts the user that the unwatched content item may be deleted from storage 204, 212.

As shown in FIG. 6, notification 612 may be shown on a screen of computing device 610. In some embodiments, different types of notifications may be provided to the user. For example, a notification may be provided in the form of at least one of an audio notification, push notification, badge notification, in-app notification, on-screen notification, or any suitable type of notification that can be provided in system 100.

In some embodiments, control circuitry 202 identifies an event that triggers the notification to be generated. In one example, a time corresponding to a triggering event may be a transmission time of the next episode of the series of sequentially ordered content items. Notification 612 may retrieve scheduling information from media guidance data source 108 and determine when the next episode of “Walking Dead” will be aired. Based on the next episode's scheduled transmission date, control circuitry 202 may set a specific date by which the stored content item needs to be consumed. Control circuitry 202 may provide the notification with the due date by which the user needs to watch the stored content item. If the user does not watch the stored content item by the due date that control circuitry 202 determines, then control circuitry 202 may delete the unwatched content item to save up the storage space. For example, exemplary depiction 600 shows a reminder notification indicating that “It has been a week since we recorded “Walking Dead.” Do you want to watch now? We won't record the next episode, which is scheduled to be aired next Friday, if you don't watch the recorded episodes by Friday.” User 612 may be prompted to watch the stored content items upon receiving notification 612.

In another example, the triggering event may be a due date set by the system or the user. The system may use attributes of a content item and the user profile data to personalize the due date for a respective content item. For example, the due date of the same content item may be different based on the user. Control circuitry 202 uses the due date to determine when to generate the notification.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
receiving a request to store a content item of a series of sequentially ordered content items;
determining, based on first user account data, whether the request is a new request for a first user account;
upon determining that the request is the new request for the first user account, storing a predetermined number of content items of the series of sequentially ordered content items in a storage device;
determining whether a threshold amount of the predetermined number of content items has been displayed on a device associated with the first user account; and
upon determining that the threshold amount of the predetermined number of content items has not been displayed, causing a notification to be displayed on the device, wherein the notification comprises:
an option to watch the stored predetermined number of content items, and
an alert indicating that additional content items will not be recorded until the threshold amount of the stored predetermined number of content items has been displayed.

2. The method of claim 1, further comprises:
deleting the stored predetermined number of content items from the storage device in response to determining that the threshold amount of the predetermined number of content items has not been displayed.

3. The method of claim 1, wherein determining whether the request is the new request for the first user account comprises determining whether the content item has been broadcast prior to receiving the request.

4. The method of claim 1, wherein determining whether the request is the new request for the first user account comprises determining whether the content item has been displayed for the first user account prior to receiving the request.

5. The method of claim 1,
wherein the additional content item is scheduled to be broadcast at a later time than the predetermined content items.

6. The method of claim 5, further comprising:
determining a scheduled time of the additional content item for transmission; and
providing the notification at a time prior to the scheduled time of the additional content item.

7. (canceled)

8. The method of claim 1, further comprising:
identifying a second user account on the device that is associated with the first user account; and
upon determining that the threshold amount of the predetermined number of content items has been displayed for the second user account, preventing the notification from being displayed.

9. The method of claim 1, wherein the threshold amount comprises at least one of a predefined number of played content items and a predefined amount of time spent on playing the content items.

10. The method of claim 1, wherein the predetermined number of content items is stored in the storage device prior to receiving the request to store the content item based on the first user account data.

11. A system comprising:
a storage device; and
control circuitry configured to:
receive a request to store a content item of a series of sequentially ordered content items;
determine, based on first user account data, whether the request is a new request for a first user account;
upon determining that the request is the new request for the first user account, store a predetermined number of content items of the series of sequentially ordered content items in a storage device;
determine whether a threshold amount of the predetermined number of content items has been displayed on a device associated with the first user account; and
upon determining that the threshold amount of the predetermined number of content items has not been displayed, cause a notification to be displayed on the device, wherein the notification comprises:
an option to watch the stored predetermined number of content items, and
an indication that additional content items will not be recorded until the threshold amount of the stored predetermined number of content items has been displayed.

12. The system of claim 11, wherein control circuitry is configured to:
delete the stored predetermined number of content items from the storage device in response to determining that the threshold amount of the predetermined number of content items has not been displayed.

13. The system of claim 11, wherein the control circuitry, when determining whether the request is the new request for the first user account, is further configured to determine whether the content item has been broadcast prior to receiving the request.

14. The system of claim 11, wherein the control circuitry, when determining whether the request is the new request for the first user account, is further configured to determine whether the content item has been displayed for the first user account prior to receiving the request.

15. The system of claim 11,
wherein the additional content item is scheduled to be broadcast at a later time than the predetermined content items.

16. The system of claim 15, wherein control circuitry is configured to:
determine a scheduled time of the additional content item for transmission; and
provide the notification at a time prior to the scheduled time of the additional content item.

17. (canceled)

18. The system of claim 11, wherein control circuitry is configured to:
identify a second user account on the device that is associated with the first user account; and
upon determining that the threshold amount of the predetermined number of content items has been displayed for the second user account, prevent the notification from being displayed.

19. The system of claim 11, wherein the threshold amount comprises at least one of a predefined number of played content items and a predefined amount of time spent on playing the content items.

20. The system of claim 11, wherein the predetermined number of content items is stored in the storage device prior to receiving the request to store the content item based on the first user account data.

21.-50. (canceled)

51. The method of claim 1, wherein the alert further includes an indication that the stored predetermined number of content items has not been displayed.

52. The system of claim 11, wherein the alert further includes an indication that the stored predetermined number of content items has not been displayed.
